(19) United States
(12) Patent Application Publication
(10) Pub. No.: US 2025/0252465 A1
(43) Pub. Date: Aug. 7, 2025

(54) SURFACING LOCAL MERCHANTS WITH ENHANCED REWARD OPPORTUNITIES

(71) Applicant: American Express Travel Related Services Company, Inc., New York, NY (US)

(72) Inventors: Wilbert Alexander Abreu, Scotch Plains, NJ (US); Murari Chakrakodi, Sunrise, FL (US); Vinay Kumar Chedalla, Phoenix, AZ (US); Arita Das, Fountain Hills, AZ (US); Bailey J. Fallon, Hilton Head, SC (US); Aleksander Guzman, Brooklyn, NY (US); Gopesh Kumar, Scottsdale, AZ (US); Evan Y-Kit Lim, New York, NY (US); Srinivasa Mathkur, Phoenix, AZ (US); Darren John Murarik, Matawan, NJ (US); Stephen J. Nunez, Elizabeth, NJ (US); Jason Scott, New York, NY (US); Shoshana Sokolic, Elizabeth, NJ (US)

(21) Appl. No.: 19/094,388

(22) Filed: Mar. 28, 2025

Related U.S. Application Data
(62) Division of application No. 17/399,412, filed on Aug. 11, 2021.

(51) Int. Cl. G06Q 30/0282; G06Q 30/0226; G06Q 30/0251

(52) U.S. Cl. CPC G06Q 30/0282; G06Q 30/0231; G06Q 30/0259; G06Q 30/0269

(57) ABSTRACT

Disclosed are various embodiments for surfacing local merchants with enhanced rewards opportunities to customers. First, a computing device can determine that a merchant satisfies a qualification criterion and add the merchant to a list of qualified merchants. Then, the computing device can send a message to a client application executing on a client device associated with a transaction account, the notification indicating that the merchant is a qualified merchant. Then, the computing device receives a first message from the client device indicating that a user of the client device is travelling from a first location to the merchant. Later, the computing device receives a second message from the client device indicating that the user of the client device has arrived at the merchant. A distance traveled by the client device is calculated and award value is calculated based on the distance traveled.

### CROSS-REFERENCE TO RELATED APPLICATIONS

This divisional application claims priority to, and the benefit of, co-pending U.S. patent application Ser. No. 17/399,412, entitled “SURFACING LOCAL MERCHANTS WITH ENHANCED REWARD OPPORTUNITIES” and filed on Aug. 11, 2021, which is incorporated by reference as if set forth herein in its entirety.

### BACKGROUND

Business for merchants can often vary over time due to various factors. For example, extrinsic factors such as global epidemics or pandemics could result in customers isolating at home instead of shopping in stores. As another example, merchants in seasonal locations, such as tourist or vacation destinations, may have a decline in customers and revenue in the off-season. As a result, many merchants may find themselves struggling at certain times. Although many of their customers might be inclined to make an extra effort to shop at their favorite merchants to help them financially, many merchants are unwilling to advertise declines in customers, foot traffic, or revenues because they wish to avoid bad publicity. Moreover, a decline in transactions at a merchant further leads to declines in revenue for issuers of debit, credit, or charge cards.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in the network environment of FIG. 1 to identify qualified merchants according to various embodiments of the present disclosure.

FIG. 3 is a flowchart illustrating one example of functionality implemented as portions of an application executed in the network environment of FIG. 1 to calculate an award value for a user based on a distance traveled by the user to a merchant, according to various embodiments of the present disclosure.

FIG. 4 is a flowchart illustrating an alternative example of functionality implemented as portions of an application executed in the network environment of FIG. 1 to calculate an award value for a user based on a distance traveled by the user to a merchant, according to various embodiments of the present disclosure.

FIG. 5 is a flowchart illustrating an alternative example of functionality implemented as portions of an application executed in the network environment of FIG. 1 to calculate an award value for a user based on a distance traveled by the user to a merchant, according to various embodiments of the present disclosure.

FIGS. 6A-6D are user interface diagrams illustrating an example of a user experience with various embodiments of the present disclosure.

### DETAILED DESCRIPTION

Disclosed are various approaches for surfacing local merchants with enhanced rewards opportunities to customers. These approaches can include for identifying potentially distressed merchants and surfacing them to customers or potential customers in order to encourage customers to make purchases with the merchants. For example, sales data and posts to social media platforms or review websites can be analyzed in order to detect changes in sales volume, sales revenue, or in posts related to the merchant over predefined intervals or periods of time. Declines in any of these metrics could be indicative of a decline in customer traffic related to seasonal issues or external issues such as global pandemics or epidemics that discourage customers to leave their homes.

The merchants could be surfaced to the customer in a number of ways, which are discussed in further detail in the subsequent discussion regarding the figures. For example, merchants that meet one or more qualifications could be presented to the user within an application installed on the user's device, such as an application provided by a bank or transaction account issuer. These could be presented as merchants nearby in which the user might be interested and/or merchants with which the user has made a previous purchase. In some implementations, the application on the client device could also display a map of the area surrounding the current location of the user and show where individual ones of the merchants are located.

To encourage users to shop at the qualified merchants presented to the user, users may be provided with additional awards or rewards for traveling to visit the merchant. Longer distances travelled could accrue extra rewards, subject to a predefined maximum distance. Moreover, the mode of travel could act as a rewards or award multiplier, with extra rewards or awards earned for travelling using more environmentally friendly modes of transportation.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

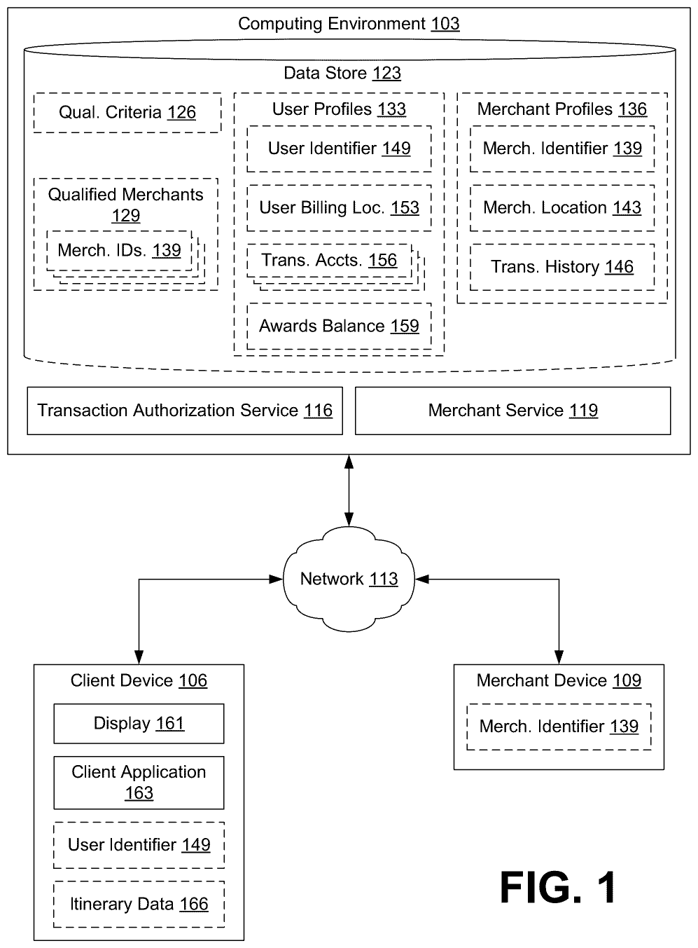

With reference to FIG. 1, shown is a network environment 100 according to various embodiments. The network environment 100 can include a computing environment 103, one or more client device 106, and one or more merchant terminals 109. The computing environment 103, the client device(s) 106, and the merchant terminal(s) 109 which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include a transaction authorization service 116, a merchant service 119, and other applications, services, processes, systems, engines, or functionality not discussed in detail herein.

Also, various data is stored in a data store 123 that is accessible to the computing environment 03. The data store 123 can be representative of a plurality of data stores 123, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 123 is associated with the operation of the various applications or functional entities described below. This data can include one or more qualification criteria 126, a list of qualified merchants 129, one or more user profiles 133, one or more merchant profiles 136, and potentially other data.

A qualification criterion 126 can represent a criteria for selecting individual merchants for inclusion in the list of qualified merchants 129. Examples of a qualification criterion 126 can include changes in the number of visits to the merchant over a predefined period or interval of time, a rate of change in transaction volume for the merchant over a predefined interval of time, a rate of change in sales with the merchant over a predefined interval of time, etc. In some instances, multiple qualification criterion 126 can be used together to determine whether individual merchants are to be included in the list of qualified merchants 129. In these instances, some qualification criteria 126 could be weighted more heavily relative to other qualification criteria 126.

The list of qualified merchants 129 can represent those merchants that are eligible to be surfaced to users of the various embodiments of the present disclosure. Accordingly, the list of qualified merchants 129 can include one or more merchant identifiers 139, which can uniquely identify a merchant and its corresponding merchant profile 136 with respect to other merchants and their respective merchant profiles 136.

A merchant profile 136 can represent an individual merchant that accepts payments authorized by the transaction authorization service 116. Accordingly, a merchant profile 136 can include a merchant identifier 139, a merchant location 143, and a transaction history 146 of payment transactions authorized by the transaction authorization service 116. The merchant location 143 can represent the physical location of the merchant or, if the merchant has multiple locations (e.g., multiple stores), the physical location of a specific location of the merchant. The merchant location 143 could be represented in the form of a street address, geographic coordinates, etc. The transaction history 146 can represent a history of all payment transactions between the merchant and its customers. This can include the date, time, and amount, of individual transactions, as well as the identity of the customer associated with the transaction.

User profiles 133 can represent information about individual consumers who purchase goods or services using payment instruments (e.g., debit cards, credit cards, charge cards, etc.) for transactions authorized by the transaction authorization service 116. Accordingly, a user profile 133 can include a user identifier 149, a user billing location 153, one or more transaction accounts 156, and an awards balance 159. The user identifier 149 can represent any identifier that uniquely identifies a user, and therefore the user profile 133, with respect to another user or user profile 133.

The user billing location 153 can represent the physical location associated with the user, and the location that communications (e.g., notices, bills, account statements, etc.) are mailed. Accordingly, the user billing location 153 could be represented by a mailing address and/or geographic coordinates (e.g., latitude and longitude coordinates). In some implementations, the user billing location 153 can also be used as a proxy for the point of origin of travel to a merchant, as further described in the discussion of the following figures.

The transaction accounts 156 represent payment instruments associated with a user. For example, a user could have multiple debit cards, credit cards, charge cards, stored-value payment instruments, etc. under his or her control. Each of these payment instruments could be represented as a transaction account 156 associated with the user profile 133. Each transaction account 156 can include its own unique transaction account identifier, such as payment card numbers that comply with the ISO/IEC 7812 standard.

The awards balance 159 can represent an amount or value of awards or rewards earned by the user represented by the user profile 133. The awards balance 159 can be in the form of points awarded by an issuer of a transaction account 156 to the user or as a cash-equivalent credit. Points or cash-equivalent credits may be awarded to the user in response to making purchases using the transaction account 156. For example, a predefined number of points may be awarded for each dollar spent, or a predefined number of points may be awarded for making a purchase with a specified merchant.

The transaction authorization service 116 can be executed to authorize a transaction request from a merchant device 109 for payment using a transaction account 156 of a user. When a transaction is authorized, the transaction authorization service 116 can also be configured to notify the merchant service 119 of the transaction, including the merchant identifier 139 of merchant requesting the authorization, the amount of the transaction, and the transaction account 156 for which the transaction was authorized.

The merchant service 119 can be configured to perform a number of functions. For example, the merchant service 119 could be executed or configured to identify merchants for inclusion in list of qualified merchants 129. As another example, the merchant service 119 could be executed or configured to surface or notify the user of qualified merchants 129. Additionally, the merchant service 119 could be executed or configured to track user behavior in order to provide credits to the awards balance 159 of the user.

The client device 106 is representative of a plurality of client devices that can be coupled to the network 113. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 161, such as liquid crystal displays (LCDs), gas plasma-based flat panel displays, organic light emitting diode (OLED) displays, electrophoretic ink (“E-ink”) displays, projectors, or other types of display devices. In some instances, the display 161 can be a component of the client device 106 or can be connected to the client device 106 through a wired or wireless connection. The client device 106 can also include one or more wireless transmitters, such as near-field communications (NFC) transmitter, a BLUETOOTH radio, etc.

The client device 106 can be configured to execute various applications such as a client application 163 or other applications. The client application 163 can be executed by the client device 106 to access content provided by the merchant service 119 or to provide information to the merchant service 119. For example, the client application 163 could represent a mobile banking application that allows a user to access information associated with his or her user profile 133 or to make payments with one or more transaction accounts 156 using his or her client device 106. The client application 163 could also be configured to determine the current location of the client device 106 and report the current location of the client device 106 to the merchant service 119 at periodic intervals. In some implementations, the client application 163 could also be configured to notify the user of the presence of qualified merchants 129 in which the user may be interested.

The client device 106 can also store various types of information for use in the various embodiments of the present disclosure. For example, the client device 106 could store a user identifier 149, which allows a client device 106 to be associated with a user profile 133 of a specific user. However, the client device 106 could also store a device identifier that, if linked to or stored in the user profile 133, would also allow for the client device 106 to be similarly associated with a user profile 133 of a specific user. The client device 106 could also collect and store itinerary data 166, which can include information about a route or itinerary followed by the client device 106, such as the beginning and end locations of a route or itinerary followed by the client device 106, the total distance covered by the client device 106, the time that the client device 106 began its itinerary, the time that the client device 106 ended its itinerary, etc. The itinerary data 166 could also include information such as the mode of transportation used by the user of the client device 106 during the journey, such as whether the user bicycled, walked, used public transportation, drove, etc. The itinerary data 166 can recorded by the client device 106 using one or more geolocation circuits installed on the client device 106 (e.g., a global positioning system (GPS) receiver, a global navigation satellite system (GLONASS) receiver, etc.).

The merchant device 109 can represent a device present at a merchant which can be used to process a transaction with a user and request authorization of the transaction with the transaction authorization service 116. The merchant device 109 could include a dedicated point-of-sale terminal (e.g., a hardware system for processing transactions) or a computing device with software that, when payment information is entered (e.g., account holder's name, account number, account expiration date, card verification code, etc.), can request authorization of a transaction with the transaction authorization service 116. To facilitate the operation of the merchant device 109, information such as the merchant identifier 139 of the merchant operating the merchant device 109 may be stored on the merchant device 109. The merchant identifier 139 could be provided to the transaction authorization service 116 whenever the merchant device 109 submits a transaction with a user to the transaction authorization service 116 for authorization.

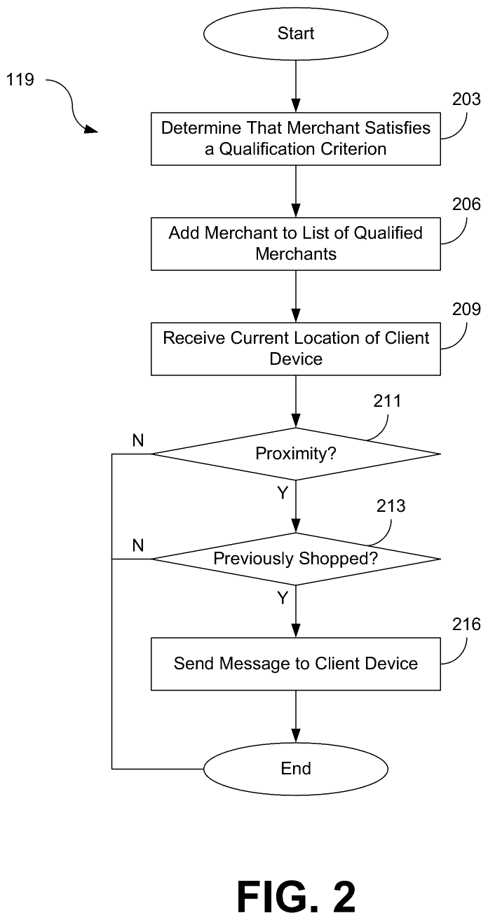

Referring next to FIG. 2, shown is a flowchart that provides one example of the operation of a portion of the merchant service 119. The flowchart of FIG. 2 provides merely an example of the many different types of functional arrangements that can be employed to implement the operation of the depicted portion of the merchant service 119. As an alternative, the flowchart of FIG. 2 can be viewed as depicting an example of elements of a method implemented within the network environment 100.

Beginning with block 203, the merchant service 119 can evaluate a merchant to determine whether the merchant meets one or more qualification criteria 126. This can be done in a number of ways, depending on the types of qualification criteria 126 used or combinations of qualification criteria 126 used. As previously discussed, this evaluation can be performed automatically or in response to a request (e.g., a request of a merchant to be included in the list of qualified merchants 129).

For example, one qualification criterion 126 could specify that the merchant has experienced a decrease in customer visits by a threshold or predefined amount over predefined interval or period of time. Such decreases in customer visits could be seasonal (e.g., declines in customers during the off-season in vacation or tourist destinations) or due to other factors (e.g., a pandemic). In order to determine whether a decrease in customer visits has occurred, the merchant service 119 could evaluate one or more data sources.

For instance, the merchant service 119 could identify a number of reviews left on a third-part review site (e.g., YELP!®, GOOGLE REVIEWS®, TRUSTPILOT®, etc.) over the predefined interval or period of time. A decreasing trend in the number of reviews (e.g., fewer reviews per week or per month over the predefined interval or period of time) could be calculated and used as a measure for a decrease in customer visits. Customer reviews might be used as a proxy for customer visits under the assumption that a decrease in reviews correlates with a decrease in customer visits.

Similarly, the merchant service 119 could query one or more social media networks (e.g., TWITTER®, FACEBOOK®, INSTAGRAM®, etc.) to retrieve data relate to the presence of social media users at the merchant. Many social media networks allow users to broadcast or otherwise advertise their presence at a particular location to other users. These features are often referred to as “check-ins” or “checking-in” for the particular location. Therefore, the merchant service 119 could query a social media network to retrieve data regarding “check-ins” of social media users over the predefined interval or period of time. A decreasing trend in the number of check-ins (e.g., fewer check-ins per week or per month over the predefined interval or period of time) could be calculated and used as a measure for a decrease in customer visits. Check-ins might be used as a proxy for customer visits under the assumption that a decrease in check-ins correlates with a decrease in customer visits.

In another example, the merchant service 119 could evaluate transaction information to determine whether a decrease in customer visits has occurred. For example, the merchant service 119 could evaluate the transaction history 146 to determine whether a decrease in the number or volume of transactions has occurred over the predefined interval or period of time (e.g., fewer transactions per week or per month over the predefined interval or period of time). A decrease in the number or volume of transactions could be used as a proxy for customer visits under the assumption that a decrease in the number of transactions correlates with a decrease in customer visits. However, changes in the number or volume of transactions could also be evaluated as its own qualification criterion 126, rather than as a proxy for changes in customer visits to the merchant.

In a similar example, the merchant service 119 could evaluate the transaction history 146 to determine whether a decrease in the volume or amount of sales revenue has occurred over the predefined period of time (e.g., fewer dollars in sales per week or per month over the predefined interval or period of time). A decrease in the amount of money spent could be used as a proxy for customer visits under the assumption that a decrease in the amount or volume of sales revenue correlates with a decrease in customer visits. However, changes in the amount or volume of sales revenue could also be evaluated as its own qualification criterion 126, rather than as a proxy for changes in customer visits to the merchant.

Moreover, some or all of these examples could be used in combination with each other to increase the accuracy of a calculation of the decrease in customer visits. For example, not every customer who visits a merchant necessarily leaves a review. Similarly, not every customer who visits a merchant necessarily checks-in with a social media network of platform. Moreover, not every customer who does visit a merchant necessarily makes a purchase. Likewise, it's possible that a single purchase could involve multiple customers (e.g., where a single customer buys items for multiple individuals and expects to be repaid later). Accordingly, some implementations may evaluate a merchant according to multiple qualification criteria 126 in order to calculate the rate of change in visits to the merchant over the predefined interval or period of time. In some of these implementations, different qualification criteria 126 may be weighted more or less heavily relative to other qualification criteria 126.

Then at block 206, after a determination that the merchant meets the specified qualification criteria 126, the merchant service 119 can add the merchant to the list of qualified merchants 129. For example, the merchant service 119 could store the merchant identifier 139 of the merchant in the list of qualified merchants 129.

Later, at block 209, the merchant service 119 can receive the current location of the client device 106. For example, the client application 163 could report the current location of the client device 106 to the merchant service 119 at periodic intervals.

In response to receipt of the current location of the client device 106, the merchant service 119 can determine that the client device 106 is within proximity to any merchants in the qualified list of merchants 129 at block 211. For example, the merchant service 119 could retrieve the merchant identifiers 139 from the list of qualified merchants 129. The merchant service 119 could then search for merchant profiles 136 with matching merchant identifiers 139 and retrieve the merchant locations 143 of the merchant profiles 136 with the matching merchant identifiers 139. The merchant service 119 could then calculate the distance between the merchant location 143 of each of the qualified merchants 129 and the current location of the client device 106. The merchant service 119 could then determine whether any the qualified merchants 129 are within a predefined distance of the client device 106 and, therefore, are within proximity to the client device 106. If client device 106 is within proximity to one or more of the qualified merchants 129, then the process can continue to block 213. Otherwise, the process can end.

At block 213, the merchant service 119 can also determine whether the user of the client device has previously shopped with any of the merchants identified at block 211. For example, the merchant service 119 could use the user identifier 149 provided by the client device 106 to search for a matching user profile 133. The merchant service 119 could then cross-reference the transaction accounts 156 associated with the user profile 133 of the user with individual transactions in the transaction history 146 of a merchant profile 136. If a user's transaction account 156 was used in a transaction stored in the transaction history 146 of a merchant profile 136, the merchant service 119 could determine that the user had previously shopped with or made a purchase with the merchant. Accordingly, the process could then proceed to block 216. However, if not matching transaction is identified, then the merchant service 119 could determine that the user had not previously shopped with or made a purchase with the merchant. As a result, the process could end.

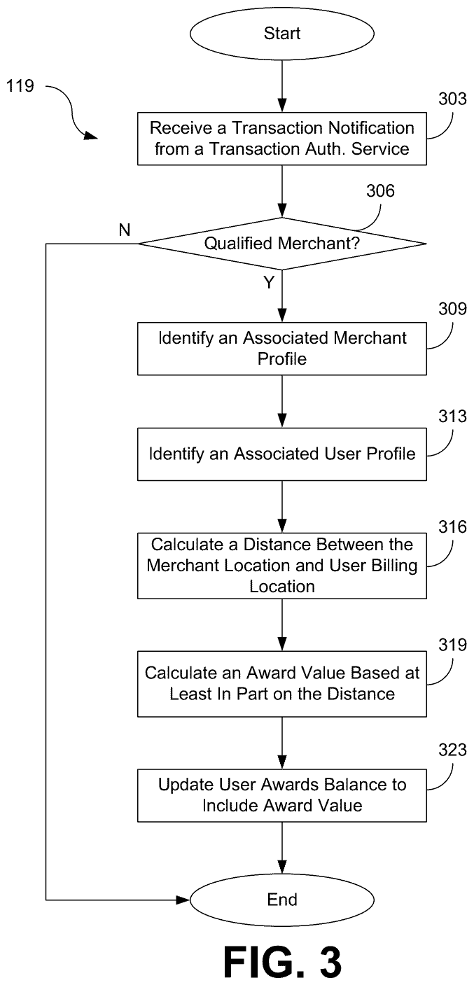

Subsequently, at block 216, the merchant service 119 can send a notification or message to the client device 106 regarding the qualified merchant(s) 129 identified at block 213. The notification or message could include the name of each identified merchant and the merchant location 143 of each identified merchant, thereby allowing the user of the client device to discover which of the qualified merchants 129 are in proximity to the client device 106. For example, the client application 163 could list the qualified merchant(s) 129 identified at block 213 and/or display their locations on a map presented to the user. In some implementations, the client application 163 also present a notification or indication that the user could accrue additional awards, rewards, or discounts for shopping with some or all of the qualified merchant(s) 129 identified at block 213. The amount of the additional awards, rewards, or discounts could be based at least in part on the distance that the user travels in order to shop at individual ones of the qualified merchant(s) 129 identified at block 213. Various approaches for calculating the amount of the additional awards, rewards, or discounts that could be based at least in part on the distance that the user travels are discussed in further detail in the paragraphs accompanying the description of FIGS. 3-5.

Referring next to FIG. 3, shown is a flowchart that provides one example of the operation of a portion of the merchant service 119 to calculate an awards value based at least in part on a distance travelled by a user to a merchant. The flowchart of FIG. 3 provides merely an example of the many different types of functional arrangements that can be employed to implement the operation of the depicted portion of the merchant service 119. As an alternative, the flowchart of FIG. 3 can be viewed as depicting an example of elements of a method implemented within the network environment 100.

Beginning with block 303, the merchant service 119 can receive a transaction notification from the transaction authorization service 116. The transaction notification can indicate that a transaction by a user with a merchant was authorized. The transaction notification can include information such as the merchant identifier 139 of the merchant with whom the transaction occurred, the date and/or time that the transaction occurred, the amount of the transaction, an account identifier for the transaction account 156 used in the transaction, and potentially other information.

Then at block 306, the merchant service 119 can optionally determine whether the merchant identified in the transaction notification is one of the qualified merchants 129. For example, the merchant service 119 could search the list of qualified merchants 129 to determine if a merchant identifier 139 in the list of qualified merchants 129 matches the merchant identifier 139 in the transaction notification. If the merchant identifier 139 in the transaction notification matches a merchant identifier 139 in the list of qualified merchants 129, then the process can proceed to block 309. However, if the merchant identifier 139 in the transaction notification fails to match a merchant identifier 139 in the list of qualified merchants 129, then the process could end. How a merchant can be added to or included in the list of qualified merchants 129 has been previously discussed in the paragraphs accompanying the description of FIGS. 1 and 2.

If the process proceeds to block 309, then the merchant service 119 can identify a merchant profile 136 associated with the merchant involved in the transaction. For example, the merchant service 119 could search the data store 123 for a merchant profile 136 with a merchant identifier 139 that matches the merchant identifier 139 that was included in the transaction notification.

Next, at block 313, the merchant service 119 can search for a user profile 133 of the user involved in the transaction with the merchant. For example, the merchant service 119 could search for a user profile 133 that is associated with the transaction account 156 that was used for the transaction. This could be done, for example, by searching for a user profile 133 with a transaction account 156 that has an account identifier that matches the account identifier of the transaction account 156 used in the transaction with the merchant.

Moving on to block 316, the merchant service 119 can calculate the distance between the merchant location 143 and the user billing location 153. This can be done using a variety of approaches. For example, if the merchant location 143 and the user billing location 153 were stored as addresses, the merchant service 119 could send a request to a third-party route planning service (e.g., GOOGLE MAPS®, CITYMAPPER®, etc.) for a route between the two addresses. The merchant service 119 could then use the distance of the route returned by the third-party route planning service as the distance between the merchant location 143 and the user billing location 153. In some instances, the merchant service 119 could specify that the third-party route planning service return a specific type of route (e.g., shortest route by time, shortest route by distance, car route, bicycle route, public transport route, etc.).

As another example, the merchant service 119 could calculate the direct distance between the merchant location 143 and the user billing location 153. For example, if the merchant location 143 and the user billing location 153 were stored as geographic coordinates, the merchant service 119 could calculate the distance between the two points using the haversine formula. Alternatively, if the merchant location 143 and the user billing location 153 were stored as addresses, the merchant service 119 could send a request to a mapping service (e.g., GOOGLE MAPS, APPLE MAPS, OPENSTREETMAPS, etc.) to convert the addresses into latitude and longitude coordinates. Once the merchant service 119 received the latitude and longitude representations of the merchant location 143 and the user billing location 153, then the merchant service 119 could calculate the distance between the two points using the haversine formula.

Then, at block 319, the merchant service 119 can calculate an award value. The amount of the award value can be based at least in part on the distance travelled between the user billing location 153 and the merchant location 143. For example, a number of points (or a cash equivalent) could be awarded equal to the number of miles or number of kilometers traveled, as represented by the distance from the user billing location 153 to the merchant location 143. In some implementations, the number of points could be equal to the round-trip distance, while in other implementations the number of points could be equal to a single leg (e.g., the distance from the user billing location 153 to the merchant location 143). In some instances, the number of points (or the cash equivalent) could be capped at a maximum value or maximum reward.

Moreover, in some implementations, the amount of the award could be multiplied in response to certain conditions. For example, a first or base amount of points (or cash equivalent) could be awarded based on the distance travelled. However, if the merchant were in the list of qualified merchants 129, then the amount of points (or cash equivalent) could be multiplied to reward the user for shopping at a qualified merchant 129.

Subsequently, at block 323, the merchant service 119 can update the awards balance 159 of the user profile 133 of the user. For example, the merchant service 119 could add the amount of the award or reward calculated at block 319 to the awards balance 159. Once the awards balance 159 for the user is updated, the process could end for this transaction.

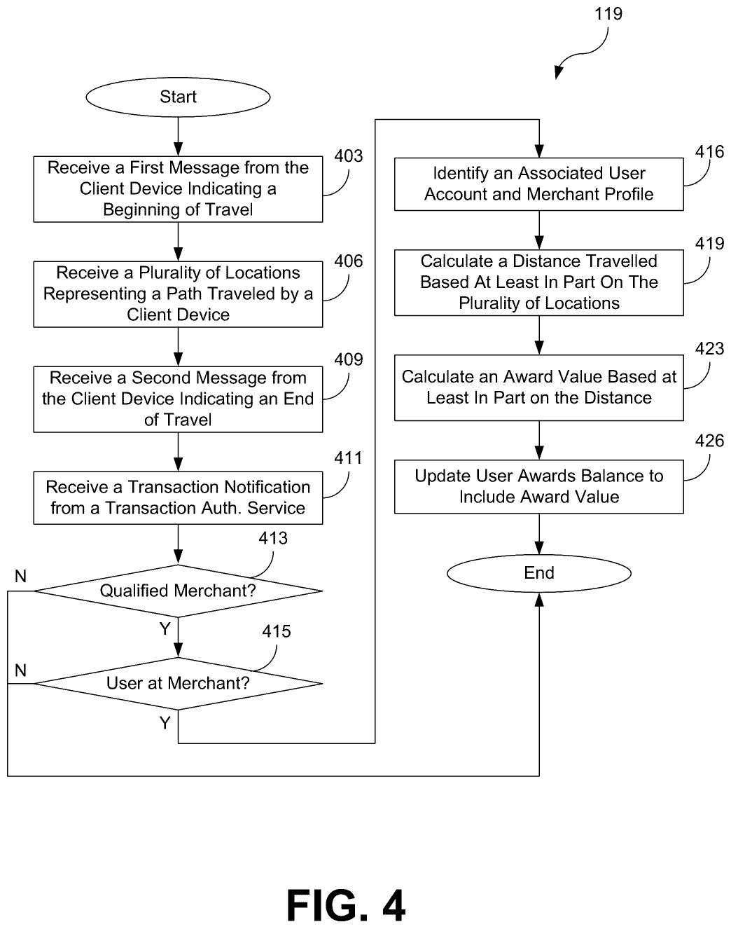

Referring next to FIG. 4, shown is a flowchart that provides an alternative example of the operation of a portion of the merchant service 119 to calculate an awards value based at least in part on a distance travelled by a user to a merchant. The flowchart of FIG. 4 provides merely an example of the many different types of functional arrangements that can be employed to implement the operation of the depicted portion of the merchant service 119. As an alternative, the flowchart of FIG. 4 can be viewed as depicting an example of elements of a method implemented within the network environment 100.

Beginning at block 403, the merchant service 119 can receive a first message from the client device 106 that a user has begun travelling. For example, the user may have provided an indication using the client application 163 installed on the client device using a user interface displayed by the client application 163. This notification may be used in order for the merchant service 119 to know the point of origin of the client device 106, and therefore the point of origin of the user, for the purposes of calculating an award value as discussed later. In some implementations, the notification may include an initial position of the client device 106.

Next, at block 406, the merchant service 119 can receive a plurality of locations from the client device 106. Each individual location of the client device 106 can include information such as the position of the client device 106 and a timestamp reflecting when the client device 106 was at that location or position. Each position or location reported by the client device 106 could be represented using geographic coordinates (e.g., latitude and longitude) and identified by the client device 106 using a geolocation circuit installed on the client device 106 (e.g., a global positioning system (GPS) receiver, a global navigation satellite system (GLONASS) receiver, etc.). Each position or location can also be reported at periodic time-intervals (e.g. every thirty (30) second, every minute, every five minutes, etc.).

Moving on to block 409, the merchant service 119 can receive a second message from the client device 106 indicating that the client device 106 has reached its destination. This notification may be used in order for the merchant service 119 that tracking of the location of the client device 106 is no longer needed for calculating the distance traveled by the client device 106 in order to calculate any awards. The second message can include a final location or position of the client device 106, and therefore a final location or position of the user.

Next, at block 411, the merchant service 119 can receive a transaction notification from the transaction authorization service 116. The transaction notification can indicate that a transaction by a user with a merchant was authorized. The transaction notification can include information such as the merchant identifier 139 of the merchant with whom the transaction occurred, the date and/or time that the transaction occurred, the amount of the transaction, an account identifier for the transaction account 156 used in the transaction, and potentially other information.

Then, at block 413, the merchant service 119 can optionally determine whether the merchant identified in the transaction notification is one of the qualified merchants 129. For example, the merchant service 119 could search the list of qualified merchants 129 to determine if a merchant identifier 139 in the list of qualified merchants 129 matches the merchant identifier 139 in the transaction notification. If the merchant identifier 139 in the transaction notification matches a merchant identifier 139 in the list of qualified merchants 129, then the process can proceed to block 415. However, if the merchant identifier 139 in the transaction notification fails to match a merchant identifier 139 in the list of qualified merchants 129, then the process could end. How a merchant can be added to or included in the list of qualified merchants 129 has been previously discussed in the paragraphs accompanying the description of FIGS. 1 and 2.

Additionally, the merchant service 119 can, at block 415, determine whether the user was present at the merchant at the time that the transaction in the transaction notification occurred. If the merchant service 119 determines that the user was present at the merchant at the time the transaction occurred, then the process can proceed to block 416. However, if the merchant service 119 determines that the user was not present at the merchant at the time the transaction occurred, then the process can end.

Various approaches could be used to determine whether the user was present at the merchant at the time that the transaction in the transaction notification occurred. For example, the merchant service 119 could compare the last location or position of the client device 106 at the time that the merchant service 119 received the second message from the client device 106 indicating an end of travel to the merchant location 143 specified in the merchant profile 136 of the merchant. If the client device 106 was located within a predefined radius or distance of the merchant location 143, then the merchant service 119 could conclude that the user was present for the transaction and had travelled to the merchant for the purpose of making a purchase from the merchant. Additionally, the merchant service 119 could compare the time that the merchant service 119 received the second message from the client device 106 to the time that the transaction authorized by the transaction authorization service 116 occurred. If the client device 106 were in the vicinity of the merchant location 143 within a predefined window of time around the time that the transaction occurred, then the merchant service 119 could conclude that the user was present for the transaction and had travelled to the merchant for the purpose of making a purchase from the merchant.

If the process proceeds to block 416, then the merchant service 119 can identify a merchant profile 136 associated with the merchant involved in the transaction and search for a user profile 133 of the user involved in the transaction with the merchant. For example, the merchant service 119 could search the data store 123 for a merchant profile 136 with a merchant identifier 139 that matches the merchant identifier 139 that was included in the transaction notification. Meanwhile, the merchant service 119 could search for a user profile 133 that is associated with the transaction account 156 that was used for the transaction. This could be done, for example, by searching for a user profile 133 with a transaction account 156 that has an account identifier that matches the account identifier of the transaction account 156 used in the transaction with the merchant.

Moving on to block 419, the merchant service 119 can calculate the distance travelled by the client device 106 associated with the user based at least in part on the plurality of locations received at block 406. For example, the merchant service 119 could calculate the distance between individual locations in the plurality of locations received to calculate the total distance travelled. For example, if the merchant service 119 received the plurality of locations A, B, C, and D in time-sequenced order, then the merchant service 119 could calculate the distance between A and B, then calculate the distance between B and C, and finally calculate the distance between C and D. The merchant service 119 could then sum these three distances to calculate the total distance travelled by the client device 106 and, therefore, by the user involved in the transaction. To calculate the distance between any two points, various approaches could be used. For example, the haversine formula could be used to calculate the distance traveled between any two locations. However, if the two locations are in close proximity to each other, other approximations or simpler formulas may be used.

Next, at block 423, the merchant service 119 can calculate an award value. The amount of the award value can be based at least in part on the distance travelled, as calculated at block 419. For example, a number of points (or a cash equivalent) could be awarded equal to the number of miles or number of kilometers traveled. In some implementations, the number of points could be equal to the round-trip distance, while in other implementations the number of points could be equal to a single leg (e.g., the distance from the point of origin to the merchant location 143). In some instances, the number of points (or the cash equivalent) could be capped at a maximum value or maximum reward.

Moreover, in some implementations, the amount of the award could be multiplied in response to certain conditions. For example, a first or base amount of points (or cash equivalent) could be awarded based on the distance travelled. However, if the merchant were in the list of qualified merchants 129, then the amount of points (or cash equivalent) could be multiplied to reward the user for shopping at a qualified merchant 129.

Subsequently, at block 426, the merchant service 119 can update the awards balance 159 of the user profile 133 of the user. For example, the merchant service 119 could add the amount of the award or reward calculated at block 423 to the awards balance 159. Once the awards balance 159 for the user is updated, the process could end for this transaction.

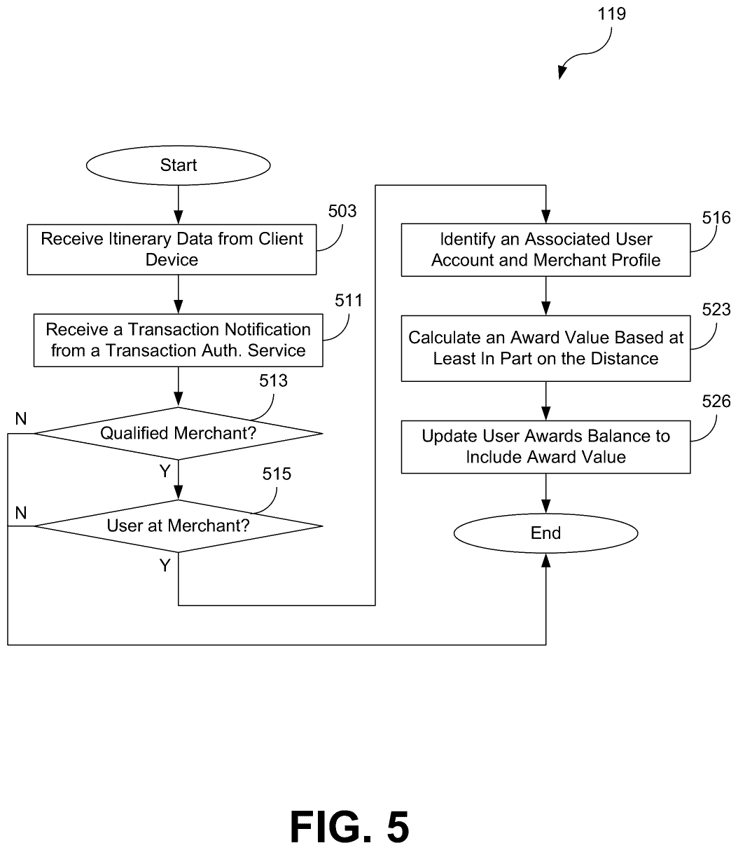

Referring next to FIG. 5, shown is a flowchart that provides an alternative example of the operation of a portion of the merchant service 119 to calculate an awards value based at least in part on a distance travelled by a user to a merchant. The flowchart of FIG. 5 provides merely an example of the many different types of functional arrangements that can be employed to implement the operation of the depicted portion of the merchant service 119. As an alternative, the flowchart of FIG. 5 can be viewed as depicting an example of elements of a method implemented within the network environment 100.

Beginning at block 503, the merchant service 119 can receive itinerary data 166 from the client device 106 (e.g., from the client application 163 executing on the client device 106). In contrast to the implementation described with respect to FIG. 4, in some implementations the client application 163 and/or client device 106 can track the beginning and end of travel of the client device 106 and, therefore, the beginning and end of travel of the user. The itinerary data 166 can recorded by the client device 106 and reported to the merchant service 119. This data can include information such as the beginning and end locations of the itinerary followed by the client device 106, the total distance covered by the client device 106, the time that the client device 106 began its itinerary, the time that the client device 106 ended its itinerary, etc. The itinerary data 166 could also include information such as the mode of transportation used by the user of the client device 106 during the journey, such as whether the user bicycled, walked, used public transportation, drove, etc.

Later, at block 511, the merchant service 119 can receive a transaction notification from the transaction authorization service 116. The transaction notification can indicate that a transaction by a user with a merchant was authorized. The transaction notification can include information such as the merchant identifier 139 of the merchant with whom the transaction occurred, the date and/or time that the transaction occurred, the amount of the transaction, an account identifier for the transaction account 156 used in the transaction, and potentially other information.

Then, at block 513, the merchant service 119 can optionally determine whether the merchant identified in the transaction notification is one of the qualified merchants 129. For example, the merchant service 119 could search the list of qualified merchants 129 to determine if a merchant identifier 139 in the list of qualified merchants 129 matches the merchant identifier 139 in the transaction notification. If the merchant identifier 139 in the transaction notification matches a merchant identifier 139 in the list of qualified merchants 129, then the process can proceed to block 515. However, if the merchant identifier 139 in the transaction notification fails to match a merchant identifier 139 in the list of qualified merchants 129, then the process could end. How a merchant can be added to or included in the list of qualified merchants 129 has been previously discussed in the paragraphs accompanying the description of FIGS. 1 and 2.

Additionally, the merchant service 119 can, at block 515, determine whether the user was present at the merchant at the time that the transaction in the transaction notification occurred. If the merchant service 119 determines that the user was present at the merchant at the time the transaction occurred, then the process can proceed to block 516. However, if the merchant service 119 determines that the user was not present at the merchant at the time the transaction occurred, then the process can end.

Various approaches could be used to determine whether the user was present at the merchant at the time that the transaction in the transaction notification occurred. For example, the merchant service 119 could compare the last location or position of the client device 106 at the time that the merchant service 119 received the second message from the client device 106 indicating an end of travel to the merchant location 143 specified in the merchant profile 136 of the merchant. If the client device 106 was located within a predefined radius or distance of the merchant location 143, then the merchant service 119 could conclude that the user was present for the transaction and had travelled to the merchant for the purpose of making a purchase from the merchant. Additionally, the merchant service 119 could compare the time that the merchant service 119 received the second message from the client device 106 to the time that the transaction authorized by the transaction authorization service 116 occurred. If the client device 106 were in the vicinity of the merchant location 143 within a predefined window of time around the time that the transaction occurred, then the merchant service 119 could conclude that the user was present for the transaction and had travelled to the merchant for the purpose of making a purchase from the merchant.

If the process proceeds to block 516, then the merchant service 119 can identify a merchant profile 136 associated with the merchant involved in the transaction and search for a user profile 133 of the user involved in the transaction with the merchant. For example, the merchant service 119 could search the data store 123 for a merchant profile 136 with a merchant identifier 139 that matches the merchant identifier 139 that was included in the transaction notification. Meanwhile, the merchant service 119 could search for a user profile 133 that is associated with the transaction account 156 that was used for the transaction. This could be done, for example, by searching for a user profile 133 with a transaction account 156 that has an account identifier that matches the account identifier of the transaction account 156 used in the transaction with the merchant.

Next, at block 523, the merchant service 119 can calculate an award value. The amount of the award value can be based at least in part on the distance travelled, as reported by client device 106 at block 503. For example, a number of points (or a cash equivalent) could be awarded equal to the number of miles or number of kilometers traveled. In some implementations, the number of points could be equal to the round-trip distance, while in other implementations the number of points could be equal to a single leg (e.g., the distance from the point of origin to the merchant location 143). In some instances, the number of points (or the cash equivalent) could be capped at a maximum value or maximum reward.

Moreover, in some implementations, the amount of the award could be multiplied in response to certain conditions. For example, a first or base amount of points (or cash equivalent) could be awarded based on the distance travelled. However, if the merchant were in the list of qualified merchants 129, then the amount of points (or cash equivalent) could be multiplied to reward the user for shopping at a qualified merchant 129. As another example, the amount of the award could be adjusted to encourage more environmentally friendly modes of travel, with a bonus given to travel involving walking, bicycling, or using public transportation.

Subsequently, at block 526, the merchant service 119 can update the awards balance 159 of the user profile 133 of the user. For example, the merchant service 119 could add the amount of the award or reward calculated at block 523 to the awards balance 159. Once the awards balance 159 for the user is updated, the process could end for this transaction.

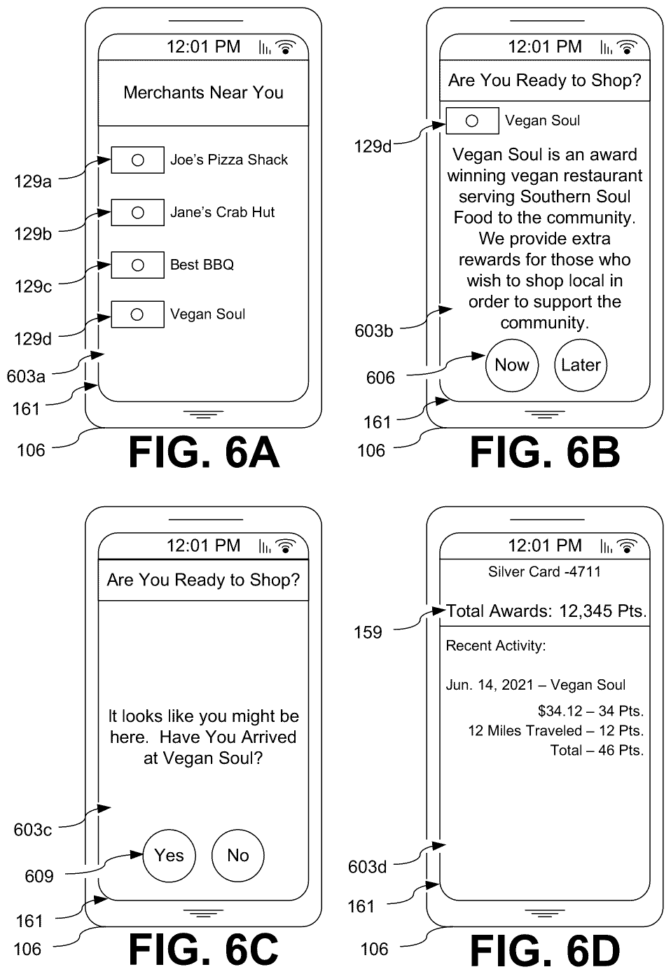

FIGS. 6A-6D are user interface diagrams depicting an example user experience according to the various embodiments of the present disclosure as previously depicted in FIGS. 1-5.

Beginning with FIG. 6A, an example of a client device 106 is illustrated. A user interface 603a can be generated by the client application 163 and presented to the user using the display 161 of the client device 106. Qualified merchants 129a, 129b, 129c and 129d are presented within the user interface 603a using any of the previously described approaches.

Then, as shown in FIG. 6B, a user could be presented with an option to indicate that they are about to begin travel to a selected one of qualified merchants 129a, 129b, 129c or 129d. For example, if the user had selected qualified merchant 129d using user interface 603a, then user interface 603b could provide a prompt for the user to travel to qualified merchant 129d to earn additional rewards. Within user interface 603b, the user could have the option to indicate using a user interface element 606 that the user was on his or her way or otherwise about to begin travelling to the selected qualified merchant 129d. As previously discussed, once the user confirms that he or she is on his or her way to the selected qualified merchant 129d, the client application 163 could cause the client device 106 to send the current location and time of the client device 106 to the merchant service 119 for calculating any future awards or rewards.

Next, as illustrated in FIG. 6C, the user could be presented with a user interface 603c once they approach their destination (e.g., the location of selected qualified merchant 129d). For example, the client application 163 of the client device 106 could compare the current location of the client device 106 to the merchant location 143 of the selected qualified merchant 129d. If the current location of the client device 106 is within a predefined distance or radius of the merchant location 143, then the client application 163 could present a user interface 603c on the display of the client device 106. The user interface 603c could notify the user that he or she is near his or her destination and prompt the user to confirm his or her arrival using a user interface element 609. As previously discussed, once the user confirms his or her arrival, the client application 163 could cause the client device 106 to send the current location and time of the client device 106 to the merchant service 119 for calculating any future awards or rewards.

Then, as depicted in FIG. 6D, a user could check his or her awards balance 159 using the client application 163 installed on the client device 106. The awards balance 159 could then be displayed within the user interface 603d by the client application 163 on the display 161 of the client device 106. Recent awards activity could also be shown within the user interface 603d. This recent activity could include awards earned for recent purchases, as well as any awards earned for travelling to a qualified merchant 129, as previously discussed.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered file systems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
determining that a merchant satisfies a qualification criterion;
adding the merchant to a list of qualified merchants based at least in part on a determination that the merchant satisfies the qualification criterion;
sending a notification to a client application executing on a client device associated with a transaction account, the notification indicating that the merchant is a qualified merchant;
receiving a first message from the client device, the first message indicating that a user of the client device is travelling from a first location to the merchant;
receiving a second message from the client device, the second message indicating that the user of the client device has arrived at the merchant and the second message comprising a second location of the client device;
calculating a distance traveled by the client device based at least in part on the first location and the second location;
calculating an award value based at least in part on the distance traveled; and
updating an awards balance associated with the transaction account to include the award value.

2. The system of claim 1, wherein the machine-readable instructions further cause the computing device to at least:
receive an additional plurality of locations of the client device, individual ones of the additional plurality of locations forming a path traveled between the first location of the client device and the second location of the client device; and
the distance traveled by the client device is calculated based at least in part on the path traveled between the first location of the client device and second location of the client device as represented by the additional plurality of locations.

3. The system of claim 1, wherein the machine-readable instructions further cause the computing device to at least:
receive a notification from a transaction authorization service that the transaction account has been used for a transaction with the merchant; and
the award value is calculated in response to receipt of the notification from the transaction authorization service that the transaction account has been used for a transaction with the merchant.

4. The system of claim 1, wherein the machine-readable instructions that cause the computing device to determine that the merchant satisfies the qualification criterion, when executed by the computing device, further cause the computing device to at least:
calculate a change in a number of reviews posted for a merchant to a third-party review site over a predefined interval of time; and
calculate a rate of change in visits to the merchant based at least in part on the change in the number of reviews.

5. The system of claim 1, wherein the machine-readable instructions that cause the computing device to determine that the merchant satisfies the qualification criterion, when executed by the computing device, further cause the computing device to at least:
calculate a change in a number of check-ins for the merchant registered with a social media platform over a predefined interval of time; and
calculate a rate of change in visits to the merchant based at least in part on the change in the number of check-ins.

6. The system of claim 1, wherein the machine-readable instructions that cause the computing device to determine that the merchant satisfies the qualification criterion, when executed by the computing device, further cause the computing device to at least calculate a rate of change in transaction volume with the merchant over a predefined interval of time.

7. The system of claim 1, wherein the machine-readable instructions further cause the computing device to at least:
receiving an indication from the client device regarding a mode of travel; and
the award value is further based at least in part on the mode of travel.

8. A method, comprising:
determining that a merchant satisfies a qualification criterion;
adding the merchant to a list of qualified merchants based at least in part on a determination that the merchant satisfies the qualification criterion;
sending a notification to a client application executing on a client device associated with a transaction account, the notification indicating that the merchant is a qualified merchant;
receiving a first message from the client device, the first message indicating that a user of the client device is travelling from a first location to the merchant;
receiving a second message from the client device, the second message indicating that the user of the client device has arrived at the merchant and the second message comprising a second location of the client device;
calculating a distance traveled by the client device based at least in part on the first location and the second location;
calculating an award value based at least in part on the distance traveled; and
updating an awards balance associated with the transaction account to include the award value.

9. The method of claim 8, further comprising:
receiving an additional plurality of locations of the client device, individual ones of the additional plurality of locations forming a path traveled between the first location of the client device and the second location of the client device; and
the distance traveled by the client device is calculated based at least in part on the path traveled between the first location of the client device and second location of the client device as represented by the additional plurality of locations.

10. The method of claim 8, further comprising:
receiving a notification from a transaction authorization service that the transaction account has been used for a transaction with the merchant; and
the award value is calculated in response to receipt of the notification from the transaction authorization service that the transaction account has been used for a transaction with the merchant.

11. The method of claim 8, wherein determining that the merchant satisfies the qualification criterion further comprises:
calculating a change in a number of reviews posted for a merchant to a third-party review site over a predefined interval of time; and
calculating a rate of change in visits to the merchant based at least in part on the change in the number of reviews.

12. The method of claim 8, wherein determining that the merchant satisfies the qualification criterion further comprises:
calculating a change in a number of check-ins for the merchant registered with a social media platform over a predefined interval of time; and
calculating a rate of change in visits to the merchant based at least in part on the change in the number of check-ins.

13. The method of claim 8, wherein determining that the merchant satisfies the qualification criterion further comprises calculate a rate of change in transaction volume with the merchant over a predefined interval of time.

14. The method of claim 8, wherein determining that the merchant satisfies the qualification criterion further comprises calculating a rate of change in sales with the merchant over a predefined interval of time.

15. The method of claim 8, further comprising:
receiving an indication from the client device regarding a mode of travel; and
the award value is further based at least in part on the mode of travel.

16. A non-transitory, computer-readable medium, comprising machine-readable instructions that, when executed by a processor of a computing device, cause the computing device to at least:
determining that a merchant satisfies a qualification criterion;
adding the merchant to a list of qualified merchants based at least in part on a determination that the merchant satisfies the qualification criterion;
sending a notification to a client application executing on a client device associated with a transaction account, the notification indicating that the merchant is a qualified merchant;
receiving a first message from the client device, the first message indicating that a user of the client device is travelling from a first location to the merchant;
receiving a second message from the client device, the second message indicating that the user of the client device has arrived at the merchant and the second message comprising a second location of the client device;
calculating a distance traveled by the client device based at least in part on the first location and the second location;
calculating an award value based at least in part on the distance traveled; and
updating an awards balance associated with the transaction account to include the award value.

17. The non-transitory, computer-readable medium of claim 16, wherein the machine-readable instructions, when executed by the processor, further cause the computing device to at least:
receive an additional plurality of locations of the client device, individual ones of the additional plurality of locations forming a path traveled between the first location of the client device and the second location of the client device; and
the distance traveled by the client device is calculated based at least in part on the path traveled between the first location of the client device and second location of the client device as represented by the additional plurality of locations.

18. The non-transitory, computer-readable medium of claim 16, wherein the machine-readable instructions, when executed by the processor, further cause the computing device to at least:
receive a notification from a transaction authorization service that the transaction account has been used for a transaction with the merchant; and
the award value is calculated in response to receipt of the notification from the transaction authorization service that the transaction account has been used for a transaction with the merchant.

19. The non-transitory, computer-readable medium of claim 16, wherein the machine-readable instructions that cause the computing device to determine that the merchant satisfies the qualification criterion, when executed by the processor, further cause the computing device to at least:
calculate a change in a number of reviews posted for a merchant to a third-party review site over a predefined interval of time; and
calculate a rate of change in visits to the merchant based at least in part on the change in the number of reviews.

20. The non-transitory, computer-readable medium of claim 16, wherein the machine-readable instructions that cause the computing device to determine that the merchant satisfies the qualification criterion, when executed by the processor, further cause the computing device to at least:
calculate a change in a number of check-ins for the merchant registered with a social media platform over a predefined interval of time; and
calculate a rate of change in visits to the merchant based at least in part on the change in the number of check-ins.
